(19) United States
(12) Patent Application Publication
(10) Pub. No.: US 2012/0228242 A1
(43) Pub. Date: Sep. 13, 2012

(54) SECURITY SHELVING APPARATUS AND METHOD FOR SECURELY STORING AND/OR DISPENSING RETAIL ARTICLES

(75) Inventors: Michael Vogler, Concord (CA); Joel Pollock, Concord (CA)

(73) Assignee: MARKETING IMPACT LIMITED, Concord (CA)

(21) Appl. No.: 13/415,085

(22) Filed: Mar. 8, 2012

Related U.S. Application Data
(60) Provisional application No. 61/450,383, filed on Mar. 8, 2011.

(51) Int. Cl. A47F 1/04; E05B 73/00

(52) U.S. Cl. 211/4; 211/59.3

(57) ABSTRACT

A secure product dispensing apparatus and methods for securely storing and/or dispensing one or more retail items. The apparatus and methods have a front panel that is openable and closable and a linked blocker panel for blocking a rear portion of the apparatus when the front panel is located in an open position. A lever actuator manually activatable lifts a retail item from the rear portion to a front portion of the apparatus over a blocker ramp. A single retail item is removable from the apparatus while the front panel is located in the open position.

### REFERENCE TO PRIOR APPLICATION

This application claims priority from U.S. Provisional Application No. 61/450,383, filed Mar. 8, 2011, which is incorporated herein by reference.

### FIELD OF THE DISCLOSURE

The present disclosure relates to security shelving units for retail articles and methods for securely storing and/or dispensing retail articles.

### BACKGROUND OF THE DISCLOSURE

Theft of items in retail stores is a major concern for retailers. Items that are often the target of shoplifters include over-the-counter (OTC) products such as analgesics and cough and cold medications, razor blades, camera film, batteries, videos, DVDs, smoking cessation products and infant formula. For a number of reasons, preventing theft of these products is a priority for retailers. Retailers are always looking for shelving, security devices or other apparatus that deters theft of these products while granting access to legitimate customers.

Theft has become particularly problematic for certain product categories, such as, for example, razors and/or infant formula. Many retail stores are taking these products off the shelves and placing them behind the counter or under lock and key. While effective in preventing theft of these products, such measures present a new set of problems. Specifically, customers may be deterred by having to request the product in order to make a purchase. Further, such a procedure requires that the clerk or cashier interrupt their usual duties in order to comply with a request. Finally, space for such shelving may be limited.

It would be desirable to have a security shelving or dispensing apparatus that provides effective theft deterrence of common retail items and/or OTC products without the drawbacks of other methods of deterring theft.

### BRIEF DESCRIPTION OF THE DRAWINGS

So that the features and advantages of the present disclosure can be understood in detail, a more particular description of the disclosure may be had by reference to the embodiments thereof that are illustrated in the appended drawings. It is to be noted, however, that the appended drawings illustrate one or more of numerous embodiments of this disclosure and are therefore not to be considered limiting of its scope, for the present disclosure may admit to other equally effective embodiments.

FIG. 1 illustrates a perspective view of a shelf frame with a front panel located in a closed position in an embodiment.

FIG. 2 illustrates a perspective view of a shelf frame with a front panel located in an open position in an embodiment.

FIG. 3 illustrates a side view of a product holder in an embodiment.

FIG. 4 illustrates an exploded perspective view of a lever actuator in accordance with FIG. 3 in an embodiment.

FIGS. 5A-5E illustrate cross-sectional views of a shelf frame and product holder in embodiments.

FIG. 6 illustrates a cross-sectional view of a shelf frame and product holder located in a loading position in an embodiment.

FIG. 7 illustrates a perspective view of a series of product holders which may be positionable in a shelf frame in an embodiment.

FIG. 8 illustrates three shelf frames mounted to uprights using hooks in an embodiment.

FIG. 9 illustrates three shelf frames fixed to shelves in an embodiment.

FIG. 10A illustrates a perspective view of a lever actuator in an embodiment.

FIGS. 10B and 10C illustrate side views of a lever actuator on a track in an embodiment.

FIG. 11 illustrates a cross-sectional perspective view of a shelf frame without product holders in an embodiment.

FIGS. 12A-12D illustrate side views of a security frame having an activator knob for turning a cam and/or raising at least one retail item in an embodiment

FIGS. 13A-13D illustrate side views of a security frame having an activator knob for turning a cam and/or raising at least one retail item in an embodiment.

### DETAILED DESCRIPTION OF THE DISCLOSURE

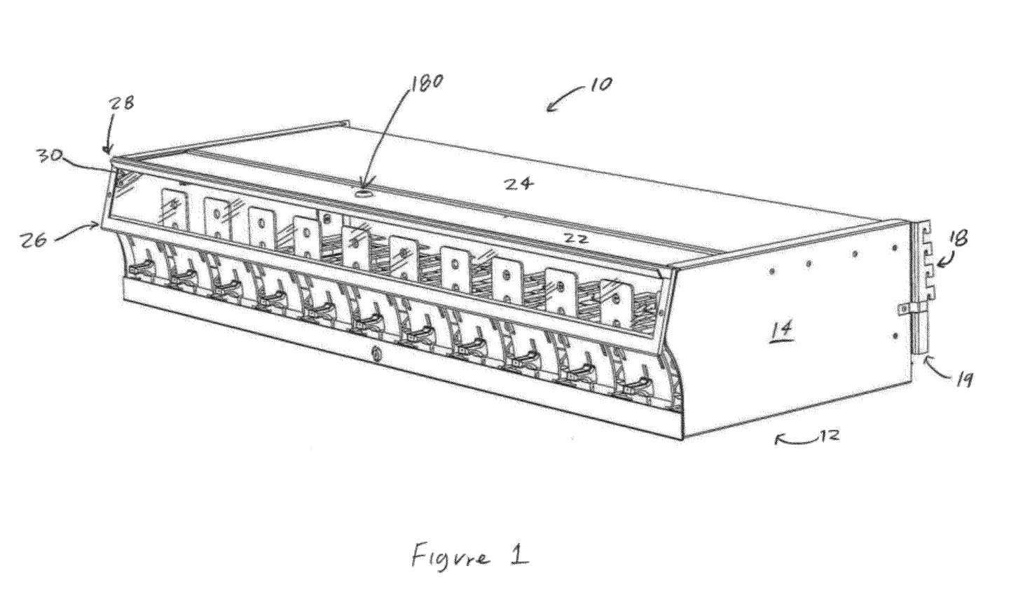

The disclosure sets forth a secure product dispensing apparatus and methods for securely storing and/or dispensing one or more retail items and/or OTC products (hereinafter “retail items”). Referring now to the drawings wherein like numerals refer to like parts, FIG. 1 illustrates a shelf frame 10 which may have a bottom panel 12 and outer side panels 14 (hereinafter “side panels 14”). An interior of the shelf frame 10 may be described in more detail below but may be generally suited for holding the retail items for sale with value. For example, the retail items may include one or more razor blade packages, pharmaceuticals, analgesics, medications, camera films, batteries, videos, DVDs, smoking cessation products, infant formula and/or the like. The retail items may be accessible singly and/or one at a time through a front-side of the shelf frame 10. It should be understood that the retail items and/or OTC products that may be dispensed from the shelf frame 10 may be any retail items and/or OTC products as known to one of ordinary skill in the art.

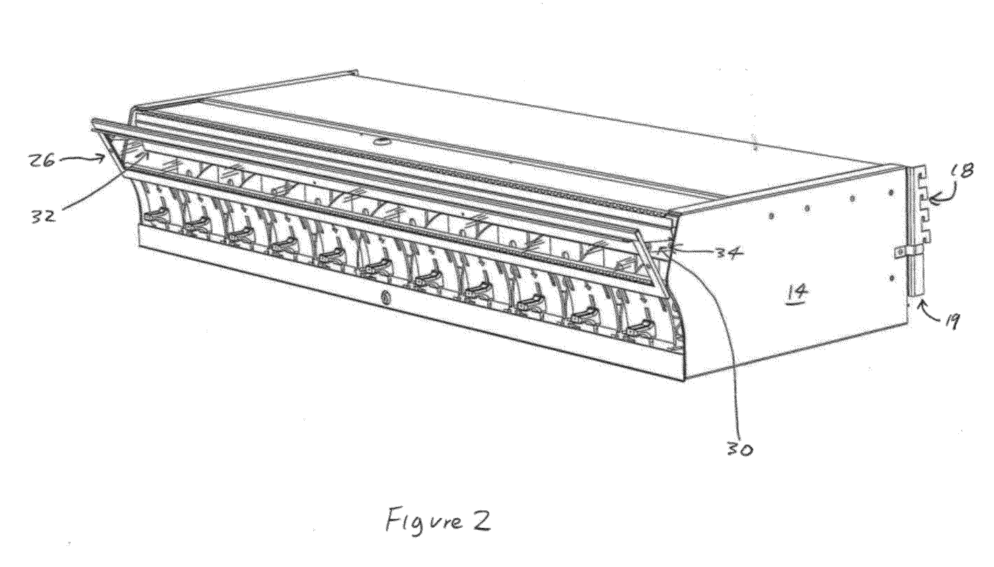

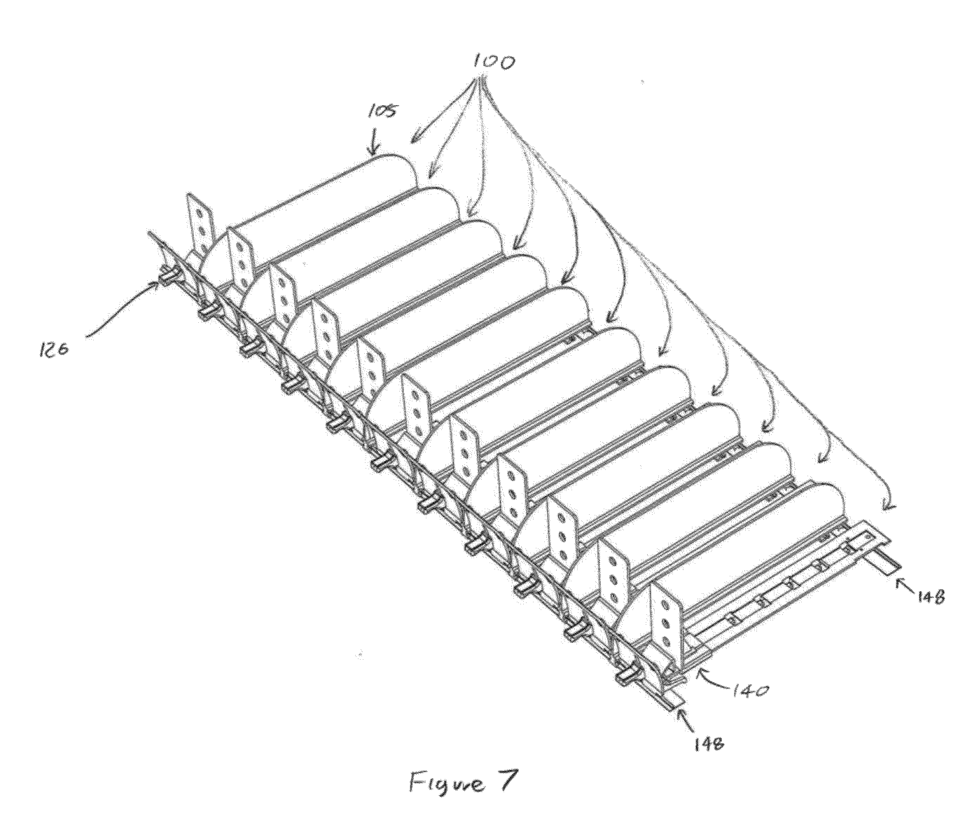

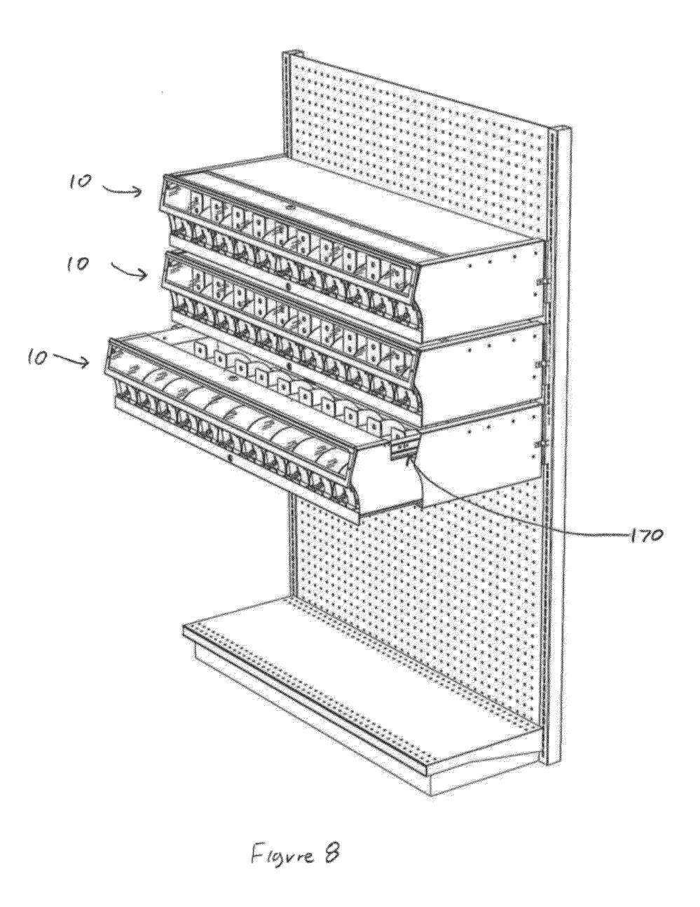

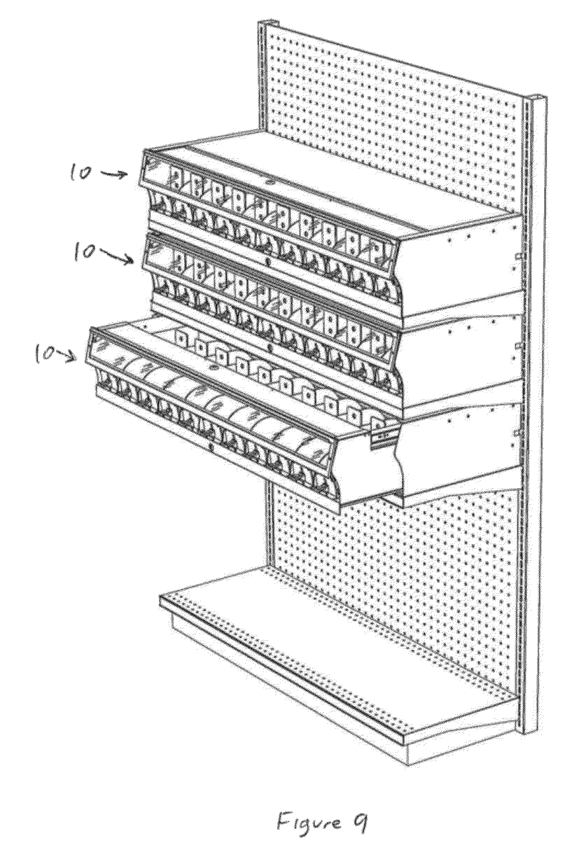

As shown in FIGS. 1, 2 and 8, at the rear of the shelf frame 10 may be one or more hooks 18 which may be suitable to engage with uprights such as with conventional shelving. With reference to FIG. 9, the shelf frame 10 may be fixed to a shelf using one or more fastening means, such as, for example, one or more bolts, screws and/or fasteners which may be placed through one or more holes (not shown in the drawings) in the bottom panel 12. The shelf frame 10 may be fixed using either the hooks 18 or the holes. As a result, the shelf frame 10 may be secured to the shelving unit. In an embodiment, the hooks 18 are removable, such as being integrated with one or more removal brackets 19 so that the brackets 19 may be removed when the shelf frame 10 is attached only using the holes as shown in FIGS. 1 and 2. The present disclosure should not be deemed as limited to a specific embodiment of the one or more fastening means for fixing the shelf frame 10 to the shelf.

Slide locks may be used to secure the shelf frame 10 to the uprights or shelf so that personnel may not remove the shelf frame 10, and/or its contents, from the uprights or shelves without, for example, a key to the slide lock. In an embodiment, the slide lock may comprise a metal bar secured to the shelf frame 10 that may engage with slots in the uprights preventing the hooks 18 from being lifted off the uprights.

The shelf frame 10 may have one or more top bars 22 to secure the top of the side panels 14 as shown in FIG. 1. Instead of, or in addition to the top bars 22, the shelf frame 10 may have a top panel 24. The top panel 24 may be present on a shelf frame 10 on the top shelf to prevent access to the retail items, within the shelf frame 10, from being removed from above. The top panel 24 may be present on one or more shelf frames 10 to provide additional security for the retail items. The shelf frame 10 may be placed on top of, or under other shelf frames 10 or in shelving units with other types of shelves.

The shelf frame 10 may have a front panel 26 which may be secured by a pivot or hinge to the side panels 14. The front panel 20 may cover approximately half of the front-side of the shelf frame 10 although the front panel 20 may cover a larger or a smaller portion of the front-side of the shelf frame 10, such as, for example, a portion of a front of the shelf frame 10 or an entire front of the shelf frame 10. The pivot with the side panels 14 may be near ends of a bottom edge of the front panel 26. The front panel 26 may have a transparent or semi-transparent window in a portion of or in an entirety of the front panel 26. In this way users may visually see into the shelf frame 10.

The front panel 26 may have a handle 28 fixed to or integrated with the front panel 26 such that a user of the shelf frame 10 may open the front panel 26 by pivoting the handle 28 inwardly and/or towards them and downward to an open position. A spring may be provided between the front panel 26 and the shelf frame 10 to return the front panel 26 to the closed position.

Linkage 30 may link the front panel 26 with a blocker panel 32 as shown in FIG. 2. The linkage 30 may include pins and tabs 34 which may rotatably connect the linkage 30 to the front panel 26 and blocker panel 32. In embodiments, the linkage 30 may include bolts, rivets, screws and/or other attachment hardware as known to one of ordinary skilled in the art.

The blocker panel 32 may pivotably hinge to a top bar 22 or top panel 24 as shown in FIG. 1. In an up position, the blocker panel 32 may be substantially aligned with the top panel 24. In this way, in the up position, a retail item may pass beneath the blocker panel 32 without interference by the blocker panel 32. The blocker panel 32 may be positioned so that at least one retail item may fit between the blocker panel 32 and the front panel 26 of the shelf frame 10. Preferably, a single retail item per shelf frame 10 may fit between the blocker panel 32 and the front panel 26 of the shelf frame 10.

When the front panel 26 may be hinged open, linkage 30 may force the blocker panel 32 into a blocked position. In the blocked position, blocker panel 32 may be oriented substantially vertically so that the blocker panel 32 may interfere with the movement of the retail items within the interior of the shelf frame 10. Closing the front panel 26 may return the blocker panel 32 to the up position. The front panel 26 may be biased to a closed position using one or more springs. In addition, or alternatively, the blocker panel 32 may be biased in an up position by one or more springs. In this way, while the front panel 26 may be open, a user may obtain a single retail item, and access to further or additional retail items may blocked.

The front panel 26 and/or blocker panel 32 may be associated with one or more electronic switches so that when the front panel 26 may be opened or the blocker panel 32 may be in blocked position, an electronic alarm or warning may be triggered. The electronic alarm and a suitable power source, such as, for example, a battery may be integrated with the shelf frame 10 or may be situated close by. In this way, any use of the shelf frame 10 to obtain the retail items may be associated with an electronic alert reducing the chances of someone holding the front panel 26 open and obtaining more than one or multiple retail items. An access panel or opening for the electronics associated with the electronic alert may be located on the top bar 22 for replacing a battery associated with the alarm or performing other maintenance with the alarm.

The shelf frame 10 may be made from metal, such as, for example, stainless steel, formed metal sheet goods, metal tubing, galvanized metal and/or plastic coated metal. Alternatively, some or all of the components of the shelf frame 10 may be made from hard plastic, such as, for example, polycarbonate, high impact styrene, acrylonitrile butadiene styrene (hereinafter “ABS”) and/or co-polyester sheet. The present disclosures should not be deemed as limited to a specific embodiment of the metal and/or hard plastic which may be usable for the shelf frame 10 and/or one or more components of the shelf frame 10.

FIG. 3 shows the shelf frame 10 may include at least one more product holder 100. Each product holder 100 may hold a plurality of retail items and/or may be substantially aligned with the side panels 14 of the shelf frame 10. Each product holder 100 may be accessible to users at the front of the shelf frame 10 through the opening below the front panel 26.

Between each product holder 100 may be one or more dividers 105 to maintain the retail items in the product holder 100. The shelf frame 10 may therefore display a number of product facings based on the number of dividers 105. In an embodiment, a shelf frame 10 may have, for example, eleven product facings with ten dividers as shown in FIG. 7. A number of product holders and dividers utilized may depend on a width of the retail items and/or may be determinable by one of ordinary skill in the art. A position of the product holders 100 may be adjustable within the shelf frame 10 to allow the same shelf frame 10 to be usable with different sized retail items.

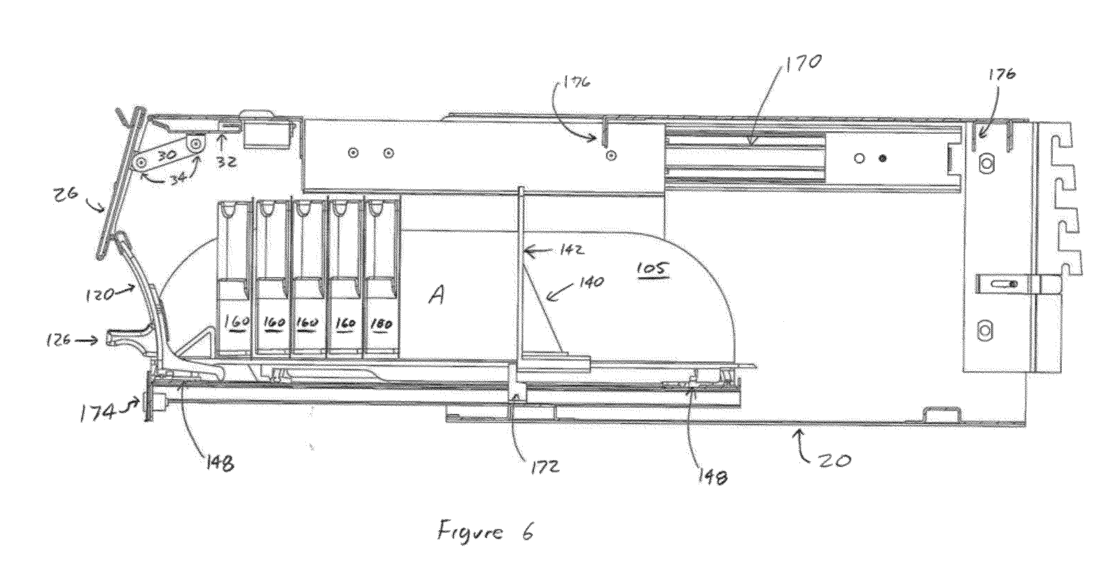

In an embodiment, the product holders 100 may be attached to rails 148, such as, for example, snap tracks as shown in FIGS. 6 and 7. The rails 148 may be attached to the shelf frame 10. As a result, the product holders 100 may be positioned on the rails 148 at the appropriate location based on a number facings and/or size of the retail items. The product holders 100 may be attached and/or connected to the rails 148 using at least one mount, such as, for example, a plastic and/or metal mount that may snap and/or lock into the rails 148 which may also be unlocked and repositioned if desired. In embodiments, the rails 148 may be mechanically attached, connected and/or secured to an interior frame. The present disclosure should not be deemed as limited to a specific embodiment of the at least one mount for attaching and/or connecting the product holders 100 to the rails 148.

Each product holder 100 may contain a lever actuator 120 accessible at the front-side of the shelf frame 10 below the front panel 26 as shown in FIG. 3. The lever actuator 120 may have a dispenser body 122 that may be integrated with or attached to a product stop ramp 124. The dispenser body 122 may substantially abut the front panel 26 and/or may be a curved panel to increase the accessibility of the retail item. In embodiments, the dispenser body 122 may be flat, or shaped to cooperate with the shape of the retail item.

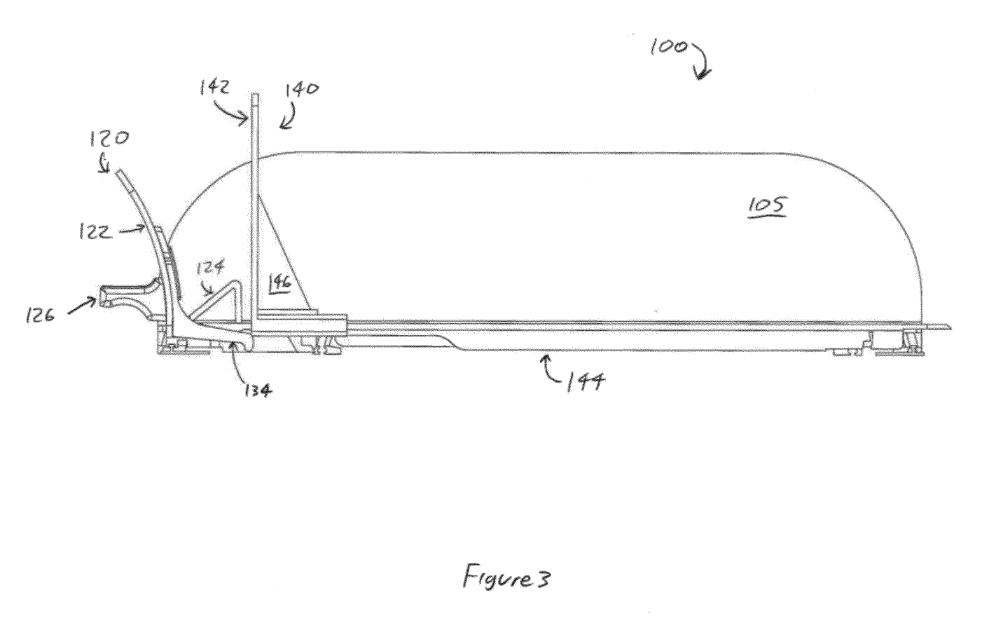

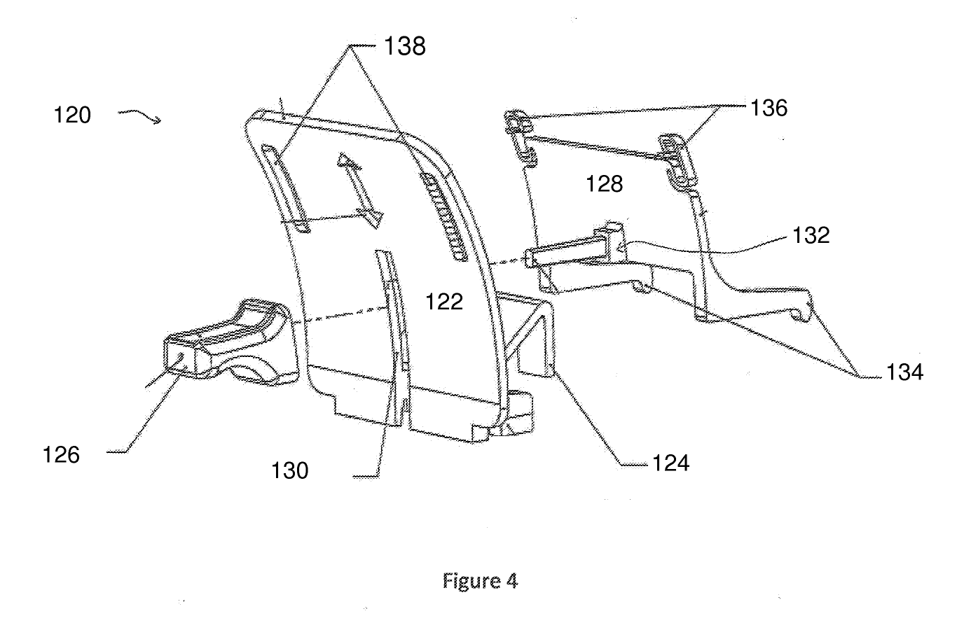

FIG. 4 shows a handle 126 may be affixed to a lever body 128 which may transverse a slot or lever track 130 in the dispenser body 122 and/or may be constrained to move in a vertical direction in the lever track 130. A rectangular slot traveller 132 may be integrated with the lever body 128 which may maintain the orientation of the lever body 128 as it may slide in the lever track 130. The handle 126 and dispenser body 122 may have instructions and/or advertising displayed on their surfaces.

Two lever forks 134 may be affixed or integrated with the lever body 128. The lever forks 134 may be oriented towards the rear of the shelf frame 10 and/or aligned on either side of the product stop ramp 124. The lever forks 134 extend past the product stop ramp 124 so that the lever forks 134 may engage with a single retail item beyond the product stop ramp 124 when the handle 126 may be activated. A spring or other means may be used to return the level forks 134 to their rest position after the handle 126 is no longer activated. In a rest position, the lever forks 134 may rest below the surface of the track 144 so that retail items may slide up against the product stop ramp 124 without interference with the lever forks 134.

Sound arms 136 may be used with the lever body 128 so that as the lever handle 126 may be activated, a mechanical sound may be generated as the sound arms 136 may transverse sound channels 138 in the dispenser body 122 as shown in FIG. 4. The sound arms 136 may be made of semi-rigid plastic with a pin that may engage a series of teeth in the sound channel. The rigidity of the plastic may bias the pin against teeth of the sound channel yet may allow the sound arm 136 to bend as the pin is drawn by the handle 126 over the teeth.

FIG. 3 shows a pusher 140 that may be associated with each lever actuator 120 in the product holder. A pusher paddle 142 on a track 144 and/or pusher plate (hereinafter “track 144”) aligned with the product holder may be biased to the front of the shelf frame 10 by a spring. The pusher paddle 142 may be mounted and secured to the track 144 using a mount 146. During loading, the pusher 140 is retracted towards the rear of the shelf frame and retail items are placed in the product holder between the lever actuator 120 and the pusher 140 on the track 144. The pusher 140 may then be released and the spring may apply the pusher 140 towards the front of the shelf frame 10 and the lever actuator 120.

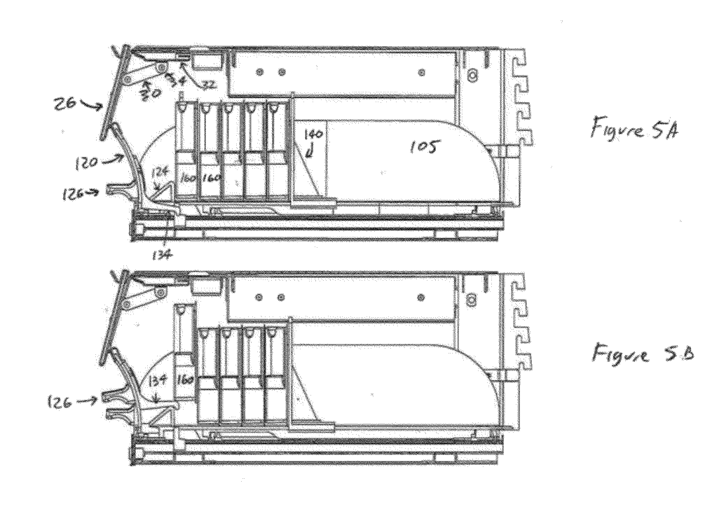

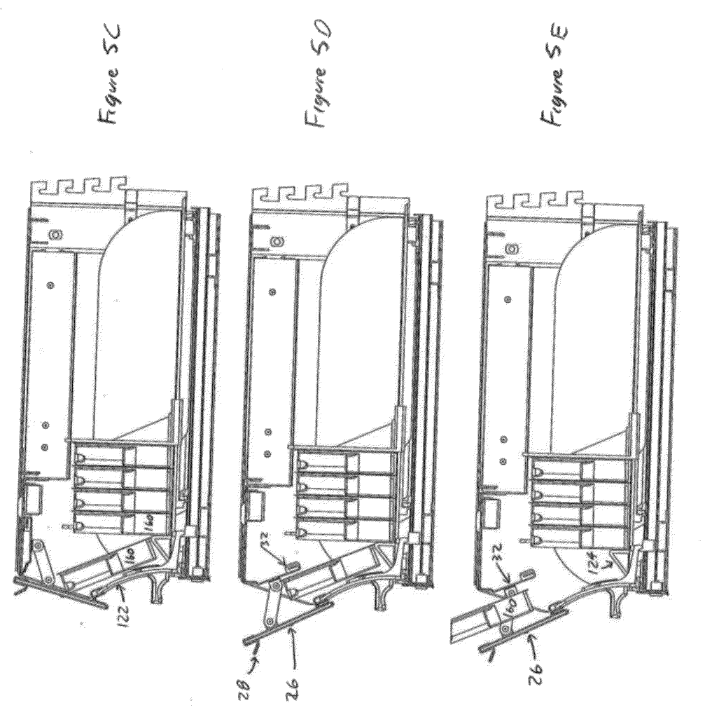

The retail items 160 may be biased towards the lever actuator 120 by the pusher 140 which may be stopped by the product stop ramp 124 as shown in FIG. 5A. With reference to FIG. 5B, when a user may activate the handle 126, the lever forks 134 may be lifted, which may lift a single retail item over the product stop ramp 124. With reference to FIG. 5C, when the retail item 160 is lifted by the forks 134 over the product stop ramp 124, the retail item 160 may rest against the dispenser body 122. The remaining retail items 160 within the product holder may remain stopped by the product stop ramp 124. After the user activates the handle 126, the lever forks 134 may return to their rest position by the spring or other means.

With reference to FIGS. 5D and 5E, when the front panel 26 is opened, such as by using the handle 28, the retail item 160 that is resting on the dispenser body 122 may be grabbed by a user through the opening formed by the front panel 26 in an open position. The remaining retail items 160 in the product holder 100 may be maintained behind the product stop ramp 124 and may be inaccessible due to the blocker panel 32.

In an embodiment, the lever actuator 120 may have a lever handle 150 and paddle lever 152 which may be fixed to each other at a pivot point as shown in FIGS. 10A-10C. The paddle lever 152 may have lever forks 134 that may move pass and/or above the product stop ramp 124. A user may press and/or activate the lever actuator 120 by pushing down on the lever handle 150 which may raise the lever forks 134 and may lift a single retail item over the product stop ramp 124. In embodiments, a sound arm may be attached to the dispenser body 122 which may engage a series of teeth affixed to the lever handle 150, the paddle lever 152 may pivot such that the lever handle 150 may be activated, and a sound may be generated. The lever actuator 120 may have a track 144 and/or may be located on the track 144 in an unengaged position as shown in FIG. 10B. When engaged, the lever forks 134 may pivot up and/or past the product stop ramp 124 as shown in FIG. 10C.

As shown in FIGS. 10B and 10C, the lever actuator 120 may have and/or may include a return spring 200 for returning the lever actuator 120 to a start position or the unengaged position from the engaged position after the lever actuator 120 may be pressed and/or activated. As a result, the return spring 200 may return or reset the lever actuator 120 to the unengaged position after the lever actuator 120 may be pressed and/or after the paddle lever 152 and/or the lever forks 134 are engaged. Further, the lever actuator 120 may have and/or may include a product cam 202 configured to provide additional security and single press functionality of the lever actuator 120. For example, when the lever handle 150 is pressed, the single retail item for dispensing may jump and/or be forced over the stop ramp 124 and rest against the product cam 202. As a result, the single retail item for dispensing and the product cam 202 may retaining the lever actuator 120 in a down or engaged position whereby the lever forks 134 may be located in an up or engaged position for preventing a second retail item from being dispensed during a single activation of the lever actuator 120. Once the single retail item for dispensing may be removed, the product cam 202 may be released and/or the return spring 200 may move or bring the lever actuator 120 back to the start or unengaged position.

In an embodiment, the shelf frame 10 may be mounted on horizontal tracks 170 or may include horizontal tracks so that the shelf frame 10, including the product holders 100, may be withdrawn and/or slide out from the supports or uprights to which it may be mounted and/or may slide back in as shown in FIG. 6. A fixed frame portion 20 may remain secured to the shelving, either by hooks 18 to the uprights or to shelves as described above. As a result, other retail items 160 may be added to the product holders 100 more easily, especially if the shelf frame 10 may be mounted below other shelf frames or shelves. Additional retail items may be added to the product holders 100 through openings in the top of the shelf frame 10 between the top bars 22 and/or top panels 24. The top panel 24 may be mounted to a fixed frame portion 20

The tracks 170 may include and/or have stops 178 to prevent the shelf frame 10 from being withdrawn completely out of the fixed frame portion 20 and/or to position the shelf frame 10 at the appropriate position when slide back in.

A lock mechanism 174 may secure the shelf frame 10 to its mounts so that only authorized personnel may slide the shelf frame 10 for reloading. A key usable with the lock mechanism 174 may operate an arm that may engage a fixed portion of the shelf frame 10 so that the shelf frame 10 may not be slid out. When the key is used to release the lock mechanism 174, the arm may disengage the fixed portion of the shelf frame 10.

In an embodiment, the pusher panel 142 may engage with pusher hooks 172 fixed to a lower cross support on the shelf frame 10 as the shelf frame 10 may be withdrawn. As the shelf frame 10 may be withdrawn from the supports or uprights on tracks, the pusher hooks 172 may retain the pusher panel 142 and/or the pusher 140 may be retracted from the lever actuator 120 for creating an open space (indicated as “A” in FIG. 6) between the pusher panel 142 and lever actuator 120 so that the retail items 160 may be easily restocked without requiring each pusher 140 to be retracted manually during reloading. As the shelf frame 10 may slide out, the pusher panel 142 for each product holder 100 may be withdrawn simultaneously. When the shelf frame 10 may be slide back to its closed position, the spring may apply the pusher panel 142 towards the lever actuator 120. In an embodiment, instead of the pusher hooks 172, connectors, such as, for example, cables may connect the pusher hooks to mounting points on the back of the shelf frame 10.

In an embodiment, the product stop ramp 124 may comprise two or more product stop ramps which may situated and/or positioned adjacent to each other. Lever forks 134 may traverse between one or more product stop ramps through suitable groves or openings.

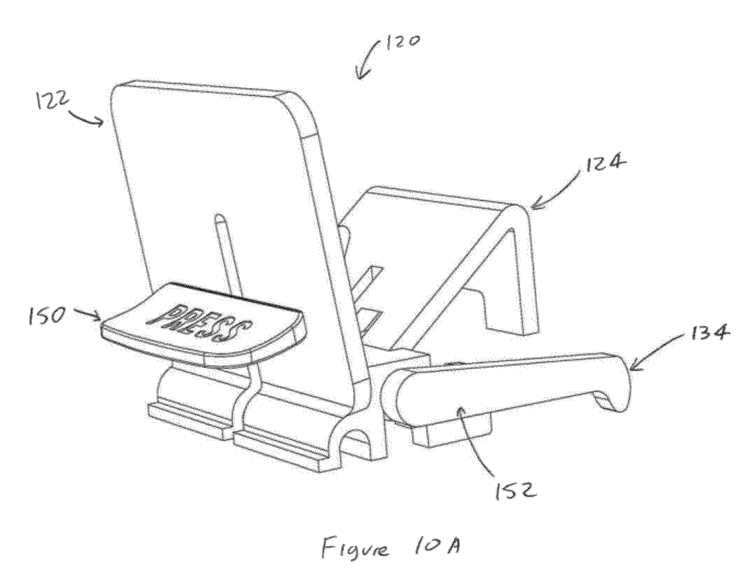

With reference to FIG. 11, the shelf frame 10 may include a night lock 180 which may be fixed in the top bar 22. The night lock 180 may be activated with a key or other mechanism and/or may rotate from an engaged position (as shown in FIG. 11) to a released position (not shown in the drawings). The night lock 180 may be fixed to a night lock arm 182 which may rotate when activated by the key or other mechanism. In an engaged position, the night lock arm 182 may block the blocker panel 32 from rotating from the up position to the blocked position. Since the blocker panel 32 may be linked to the front panel 26, the front panel 26 may be locked in the closed position. As a result, by engaging the night lock 180, the front panel 26 may not be opened so that retail items in the shelf frame may not be removed through the front opening. The night lock 180 may be activated when the store or other retail business is not open for business to prevent employees from removing retail items from the shelf frame without authorization.

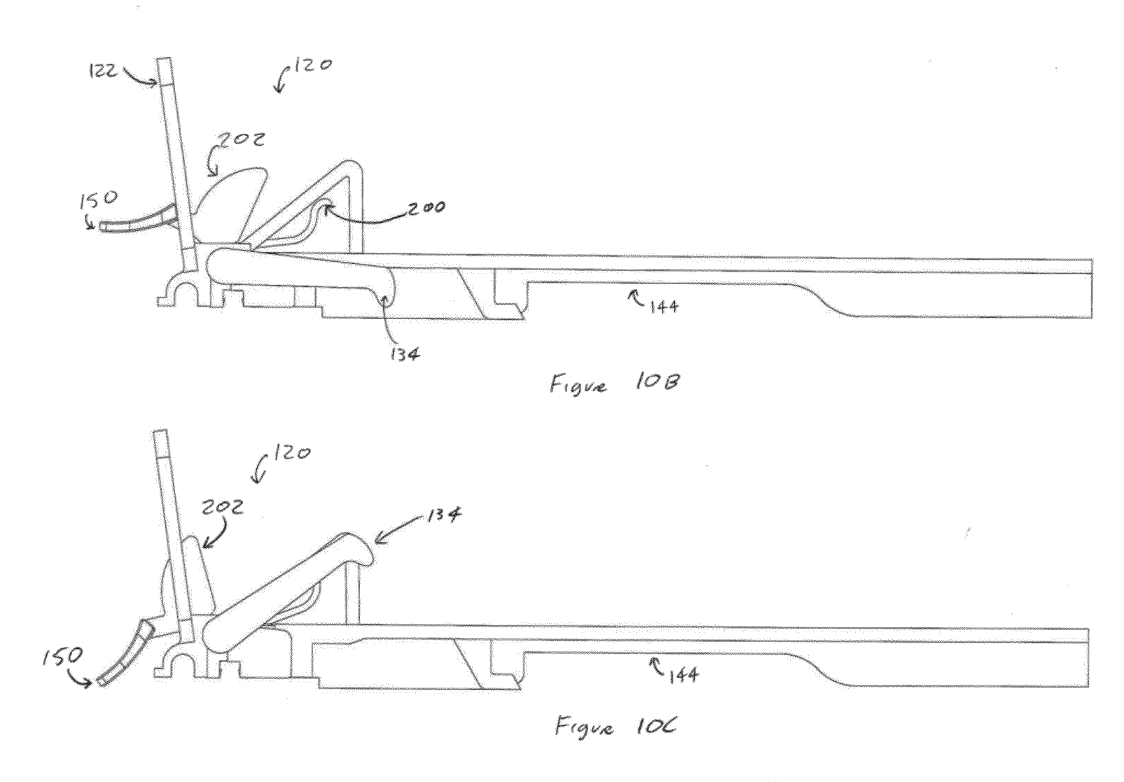

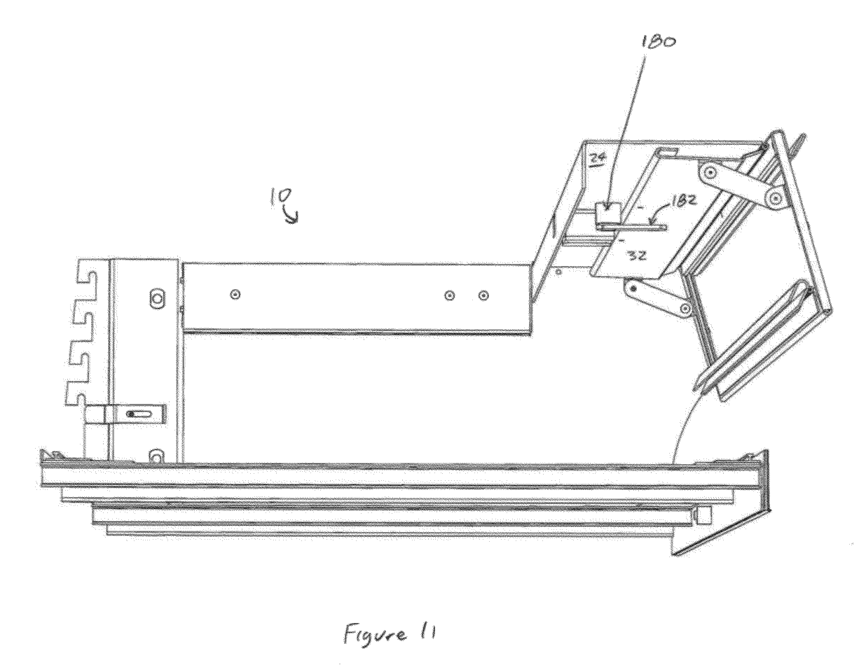

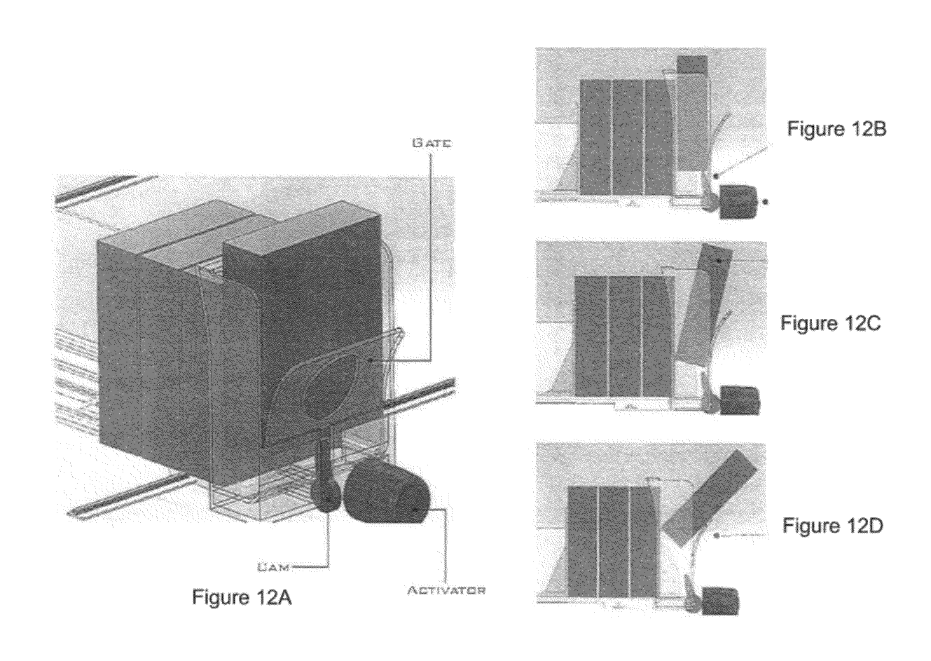

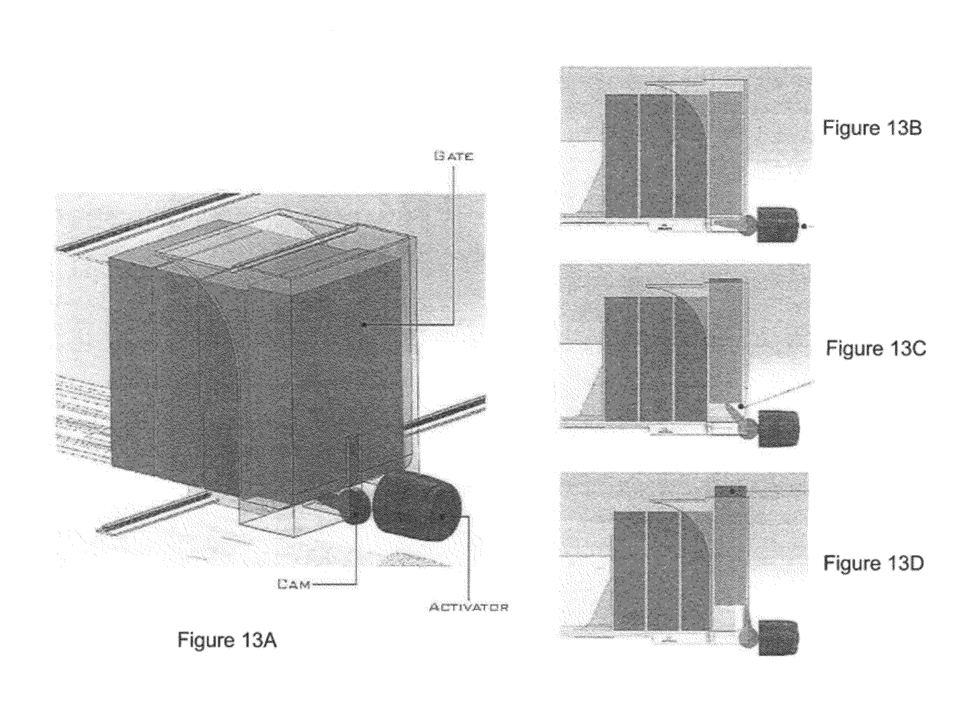

With reference to FIGS. 12A to 12D and 13A to 13D, in an embodiment, an activator may be a knob that may turn a cam to lift retail items. The knob may include a ratchet so that a sound may be generated as the knob may be manually turned. As the knob may be manually turned, the cam may lift a retail item so that the retail item may be manually accessed. A spring may return the cam and knob to the rest position after manual activation. With reference to FIGS. 12A to 12D, the dispenser body 122 may be curved. With reference to FIGS. 13A to 13D, the dispenser body 122 may be flat.

Although several embodiments of the present disclosure have been described in detail herein with reference to the accompanying drawings, it is to be understood that the disclosure is not limited to these precise embodiments, and that various changes and modifications may be effected therein by one skilled in the art without departing from the scope of spirit of the disclosure as defined in the appended claims.

We claim:

1. A secure product dispensing apparatus for one or more retail items, the apparatus comprising:
a) at least one product holder adapted for holding the one or more retail items, the at least one product holder comprising:
i) a front portion;
ii) a back portion;
iii) a pusher panel adapted for biasing the one or more retail items towards the front portion of the product holder when the one or more retail items are being held by the at least one product holder;
iv) at least one product stop ramp adapted for restraining the one or more retail items from passing from the back portion to the front portion when the one or more retail items are being held by the at least one product holder; and
v) a handle having associated forks for lifting at least one retail item over the product stop ramp such that the at least one retail item moves from the back portion to the front portion of the product holder when the one or more retail items are being held by the at least one product holder,
b) a front panel hinged at a bottom edge of the front panel, wherein the front panel is adapted to move to an open position or a closed position, wherein the front panel, when located in the open position, is configured to allow manual access to the front portion of the product holder, when located in the closed position is configured to block manual access to the product holder;
c) a blocker panel having an engaged position or an unengaged position, wherein the blocker panel, when located in the engaged position, is configured to block manual access to the back portion of the product holder and to allow manual access to the front portion of the product holder; and
d) at least one linkage located between the front panel and the blocker panel such that the blocker panel is in the engaged position when the front panel is in the open position and the blocker panel is in the unengaged position when the front panel is in the closed position;
wherein, when the one or more retail items are being held by the at least one product holder, the at least one retail item is manually accessible from the front portion of the product holder when the front panel is located in the open position and access to the one or more retail items located in the back portion of the product holder is blocked when the front panel is located in the closed position and the one or more retail items are being held by the at least one product holder.

2. A secure product dispensing apparatus comprising:
a slideable frame portion comprising the apparatus according to claim 1;
at least one track for supporting the slideable frame portion, having a travelling portion and a fixed portion in slidable contact;
a fixed frame portion secured to the fixed portion of the at least one track; and
mounts for attaching the apparatus to a shelving fixed to the fixed frame portion,
wherein the apparatus is slidable away from the shelving using the least one track.

3. The secure product dispensing apparatus according to claim 2, further comprising:
for each product holder of the at least one product holders, a pusher hook is fixed to the fixed frame portion and configured to engage a pusher panel when the slideable frame portion is slidable on the at least one track, wherein the pusher hood is configured to force the pusher panel to the back of the frame.
whereby one or more retail items is placeable in the back portion of each the product holder.

4. The secure product dispensing apparatus according to claim 1, further comprising:
a lock movable to a locked position and configured to retain the blocker panel in the unengaged position; wherein the lock is movable to an unlocked position such that the blocker panel is movable,
wherein the front panel is configured to be locked or unopenable when the lock is in the locked position.

5. The secure product dispensing apparatus according to claim 1, further comprising:
at least one electronic switch or electronic alarm associated with the front panel of the apparatus.

6. The secure product dispensing apparatus according to claim 1, further comprising:
at least one electronic switch or electronic alarm associated with the blocker panel of the apparatus.

7. A method for securely storing and dispensing at least one retail item, the method comprising:
providing the secure product dispensing apparatus according to claim 1; and
storing a plurality of retail items in the apparatus by positioning the plurality of retail items in the back portion of the at least one product holder.

8. The method according to claim 7, further comprising:
securing the plurality of retail items in the back portion of the at least one product holder by maintaining the front panel of the apparatus in the closed position.

9. The method according to claim 7, further comprising:
moving at least one retail item from the back portion to the front portion of the at least one product holder.

10. The method according to claim 9, further comprising:
moving the front panel of the apparatus from the closed position to the open position to provide access to the front portion of the at least one product holder.

11. The method according to claim 10, further comprising:
manually accessing the front portion of the at least one product holder via the front panel when the front panel is located in the open position.

12. The method according to claim 11, further comprising:
dispensing a single retail item from the apparatus by manually accessing the single retail item from the front portion of the at least one product holder via the front panel when the front panel is located in the open position.

13. The method according to claim 10, further comprising:
moving the blocker panel to the engaged position such that the blocker panel blocks manual access to the back portion of the product holder.
